(19) United States
(12) Patent Application Publication
(10) Pub. No.: US 2007/0126249 A1
(43) Pub. Date: Jun. 7, 2007

(54) Concrete lifting eye-flexi lift

(76) Inventor: Terry Allan Leach, Middleburg, FL (US)

Correspondence Address: Wilson Daniel Swayze, Jr, 3804 Clearwater Ct., Plano, TX, 75025, US

(21) Appl. No.: 11/295,982

(22) Filed: Dec. 7, 2005

(51) Int. Cl. B66C 1/00

(52) U.S. Cl. 294/1.1

(57) ABSTRACT

A lifting apparatus for lifting a load includes a saddle for distributing a weight of the load and having a hollow housing, a flexible wire rope to pass through an opening of the saddle, a stop connected to each end of the flexible wire rope.

### FIELD OF THE INVENTION

The present invention relates to a load lifting apparatus which is suitable for use in material handling operations, for example carrying loads, which enables loads of various shapes and structures to be readily moved and to be easily released.

### BACKGROUND OF THE INVENTION

To lift and to move a heavy load for example a concrete block or pipe to a desired position are usually desired at a construction site, particularly a construction site of a road or large building. To lift and to move the heavy load, a wire rope or chain may be wound around the load, and the other end of the wire rope or chain may be engaged with a hook of the material-handling equipment. In this state, the load is lifted and moved to the desired position, and then, the wire rope or chain is removed from the load. Alternatively, some loads are lifted and moved to a desired position through the use of an engagement member such as a bolt or hook having been previously attached to the load. Under these circumstances, a wire rope or chain is attached to the engagement member and the other end of the wire rope or chain is attached to a hook of the material-handling equipment. The material-handling equipment may move the load to the desired location, and then after the load has been moved to the desired location, the wire rope is disengaged from the engagement member which has been attached to the load.

The material-handling equipment, for example a crane, may have a clamping apparatus for clamping to the load to be lifted. This clamping apparatus may be opened by human power or by using a jig for example a hydraulic device to pick up the load to be lifted.

One such clamping device is described in U.S. Pat. No. 6,286,881 where a load lifting apparatus is disclosed that is suitable for use in material-handling operations to enable loads of various shapes and structures for example concrete products to be clamped and released.

Another lifting apparatus is described in U.S. Pat. No. 3,300,062 that describes a lifting apparatus which is capable of lifting pre-cast concrete walls. This patent describes a lifting apparatus having a weight distributing or load spreading units in combination with a lifting unit.

A further lifting apparatus is described in U.S. Pat. No. 2,589,954 that describes a lifting apparatus for lifting and conveying or moving concrete wall slabs. This lifting apparatus allows a concrete wall slab to be raised from a flat or horizontal position to substantially upright position.

### SUMMARY OF THE INVENTION

It is an object of the invention to provide a lifting apparatus which is capable of efficiently raising extremely heavy objects such as walls, boxes, cylinders and pipes formed from concrete or similar type of material.

It is an object of the present invention to provide a lifting apparatus which is of compact and lightweight construction and can be formed with concrete or similar type material.

It is an object of the present invention to provide a lifting apparatus which is flexible and can be connected to a wire mesh or Rebar and formed with concrete.

The present invention provides a lifting apparatus which significantly reduces the risk of breakage of the lifting apparatus below the level of the concrete and consequently reduces the risk that the object being lifted from being dropped.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the lifting apparatus of the present invention; and

FIG. 2 illustrates a cross-sectional view of lifting apparatus of the present invention and wire mesh for connection to the lifting apparatus.

### DETAILED DESCRIPTION

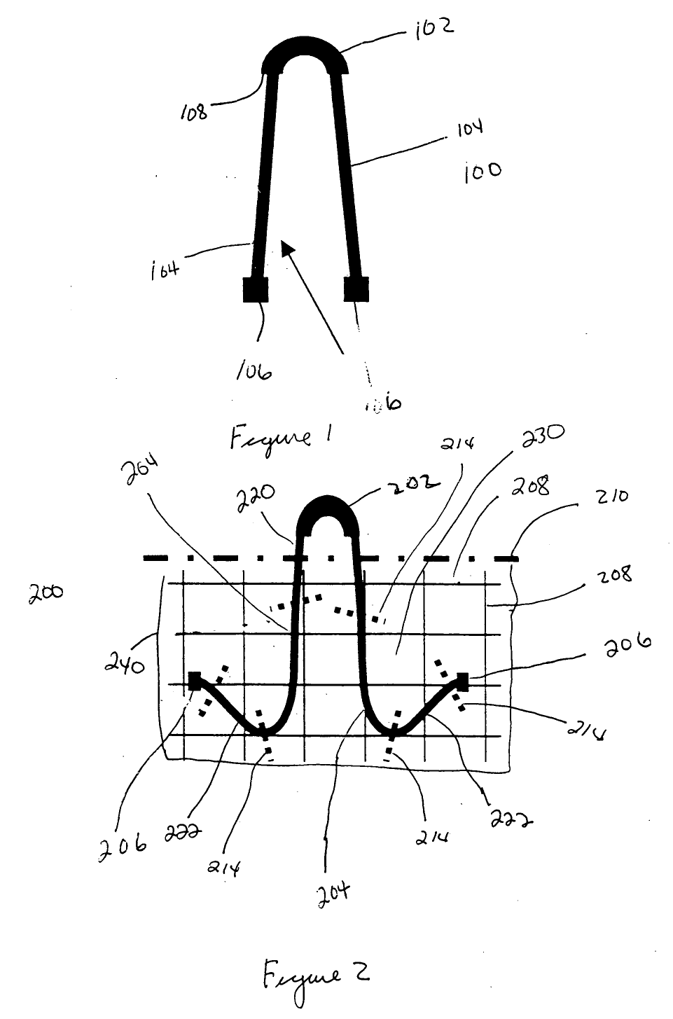

FIG. 1 illustrates the lifting apparatus 100 of the present invention. The lifting apparatus 100 is for use in concrete and other pre-cast molding materials. FIG. 1 illustrates an independent wire rope core (I.W.R.C.) which will be referred to as simply as a wire rope 104 and which is shown as being flexible so that the wire rope 104 can be turned and connected to a wire mesh or Rebar. Additionally, the flexibility of the wire rope 104 reduces the potential breakage of the wire rope 104 below the level of the hardened concrete. The wire rope 104 may be formed from galvanized cable to increase the life of the wire rope 104. After the wire rope 104 has been connected to the wire mesh or Rebar, the wire rope 104 and the connected wire mesh or Rebar are placed in a mold in which concrete or other pre-cast molding materials are poured into the mold and hardened around the wire rope 104 to form a load such as a wall, round cylinder section, box or pipe or other such object. A portion of the wire rope 104 and saddle 102 remain external to the hardened concrete so that a hook or another wire rope can be attached to the load which is moved to a desired location. FIG. 1 additionally shows a saddle 102 formed from a tube which includes a hollow housing to allow the wire rope 104 to pass through an opening 108 of the hollow housing of the saddle 102. The saddle 102 may be approximately in the shape of a ‘C’, and the wire rope 104 exits the saddle 102 at an angle, for example 145° or some other desirable angle. FIG. 1 shows that approximately equal lengths of the wire rope 104 extend on each side of the saddle 102; although, unequal lengths of the wire rope 104 are within the scope of the present invention. The saddle 102 receives the hook or another wire rope so that the load can be moved, and the saddle 102 distributes the weight of the load along a portion of the wire rope 104, avoiding a concentration of weight of the load at a single point on the wire rope 104. The saddle 102 and a wire rope 104 are free to move with respect to each other, and this freedom of movement prevents undue stress on the wire rope 104 within the concrete. FIG. 1 additionally shows a stop 106 which may be formed from metal positioned on each end of the wire rope 104. This stop 106 is connected to the wire rope 104 and helps in preventing the wire rope 104 from slipping out of the concrete.

FIG. 2 shows a cross-sectional view of the lifting apparatus 100 which has been placed in concrete 230 or other suitable material in a mold 240. FIG. 2 shows that the wire rope 204 has been placed against a wire mesh 208 or Rebar and secured to the wire mesh 208 by wire ties 214. The number and placement of the wire ties 214 will vary. FIG. 2 shows that the wire rope 204 includes a reversed portion 222 of the wire rope 204 that has been positioned at and shaped to an approximately inverse U-shape in order to secure the wire rope 204 within the concrete 230 and an exposed portion 220 of the wire rope 204 which is external to the level 210 of the concrete 230 and which cooperates with the saddle 202 to lift the load. As a result, the weight of the load is distributed to the saddle 202 and to the wire rope 204 which distributes the weight of the load to the concrete 230 and the wire mesh 208.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A lifting apparatus for lifting a load, comprising:
a saddle for distributing a weight of said load and having a hollow housing;
a flexible wire rope to pass through an opening of said saddle;
a stop connected to each end of said flexible wire rope.

2) A lifting apparatus for lifting a load as in claim 1, wherein said saddle is approximately shaped as a ‘C’.

3) A lifting apparatus for lifting a load as in claim 1, were in said wire rope exits said saddle at approximately 145°.

4) A lifting apparatus for lifting a load, comprising:
a saddle for distributing a weight of said load and having a hollow housing;
a flexible wire rope to pass through an opening of said saddle;
a stop connected to each end of said flexible wire rope;
a wire mesh for connection to said flexible wire rope.

5) A lifting apparatus for lifting a load as in claim 4, wherein said flexible wire rope is connected to said wire mesh by a wire tie.

6) A lifting apparatus for lifting a load as in claim 4, wherein said flexible wire rope includes a reversed portion for connection to said wire mesh.

7) A lifting apparatus for lifting a load as in claim 4, wherein a portion of said flexible wire rope and said wire mesh is positioned within a mold.

8) A lifting apparatus for lifting a load as in claim 7, wherein said mold includes concrete.

9) A lifting apparatus for lifting a load as in claim 4, wherein said wire mesh includes Rebar.

10) A lifting apparatus for lifting a load as in claim 6, wherein said reversed portion is approximately shaped as an U.

11) A method for forming a lifting apparatus for lifting a load, comprising the steps of:
distributing a weight of said load on a saddle having a hollow housing;
passing a flexible wire rope through an opening of said saddle;
connecting an end of each end of said flexible wire rope to a stop;
connecting a wire mesh to said flexible wire rope.

12) A method for forming a lifting apparatus for lifting a load as in claim 11 wherein said flexible wire rope is connected to said wire mesh by a wire tie.

13) A method for forming a lifting apparatus for lifting a load as in claim 11, wherein forming a reversed portion in said flexible wire rope for connection to said wire mesh.

14) A method for forming a lifting apparatus for lifting a load as in claim 11, wherein the method includes the step of positioning a portion of said flexible wire rope and said wire mesh within a mold.

15) A method for forming a lifting apparatus for lifting a load as in claim 11, wherein the method includes the step of placing concrete within said mold.

16) A method for forming a lifting apparatus for lifting a load as in claim 11, wherein the method includes the step of connecting Rebar to said wire rope.

17) A method for forming a lifting apparatus for lifting a load as in claim 13, wherein method includes the step of forming said reversed portion as an approximate U.
